(19) United States
(12) Patent Application Publication
(10) Pub. No.: US 2015/0252199 A1
(43) Pub. Date: Sep. 10, 2015

(54) ANTI-ICE COATING FOR COMPRESSOR BLADES

(71) Applicant: MTU Aero Engines AG, Munich (DE)

(72) Inventors: Natividad LOPEZ LAVERNIA, Munich (DE); Max NIEGL, Munich (DE); Melanie HEUSING, Rinteln (DE)

(21) Appl. No.: 14/636,435

(22) Filed: Mar. 3, 2015

(30) Foreign Application Priority Data
Mar. 6, 2014 (DE) 102014204075.2

(51) Int. Cl. C09D 5/00; C09D 7/12; F01D 5/28; C09D 183/06; B05D 1/38; B05D 3/02

(52) U.S. Cl. CPC C09D 5/00; B05D 1/38; B05D 3/0254; F01D 5/284; C09D 183/06; C09D 7/1216; C08K 3/0008

(57) ABSTRACT

The present invention relates to a composition for producing a coating for components of a turbomachine having anti-ice properties, wherein the composition comprises a binder which comprises at least one silicon-organic constituent, ceramic particles, boron nitride particles and a solvent and also polytetrafluoroethylene and/or graphite. The ceramic particles can have an average or maximum grain size of less than 4 μm and the boron nitride particles can have an average or maximum grain size of less than 12 μm. In addition, the present invention relates to a process for producing a coating by means of such a composition and also a coating produced in this way and a component provided therewith.

### CROSS-REFERENCE TO RELATED APPLICATIONS

The present application claims priority under 35 U.S. C. §119 of German Patent Application No. 102014204075.2, filed Mar. 6, 2014, the entire disclosure of which is expressly incorporated by reference herein.

### BACKGROUND OF THE INVENTION

1. Field of the Invention

The present invention relates to a composition and a process for producing a coating for components of a turbomachine having anti-ice properties and also a corresponding coating and a component coated therewith of a turbomachine.

2. Discussion of Background Information

In turbomachines such as stationary gas turbines or aircraft engines, ambient air is drawn in and burned together with the fuel in the combustion chamber in order to be ejected as combustion gasses. When the ambient air is drawn in, contaminants such as sand, soot particles, salt and the like and also moisture which are present in the air also get into the turbomachine and can lead there to deposits on engine components, which can lead to impairment of the efficiency of the turbomachine by alteration of the surface quality of the components of the turbomachine due to the deposits. Particularly in the case of aircraft engines which are operated in different environments, the deposition of ice is a serious problem which is relevant to safe operation of the aircraft since ice deposits can have an adverse effect on the operating properties of components.

To counter this problem of formation of deposits of ice layers, attempts have in the past been made to provide surfaces of components with coatings or to modify the surfaces. Thus, for example, the documents EP 2 343 401 A1, EP 1 734 090 A2, EP 2 333 025 B1, US 2007/0254170 A1, EP 1 484 373 A1, EP 1 994 099 B1, U.S. Pat. No. 7,910,683 B2, EP 2 298 840 A1, EP 2 426 179 A1, 2 343 400 A1, US 2003/0232941 A1 and DE 35 11 349 A1 describe surface modifications and coatings which are said to prevent formation of ice on various components and sometimes also on components of aircraft engines.

However, the known anti-ice layers either display unsatisfactory anti-ice properties or are not suitable for long-term and reliable use and the environmental conditions which are expected or sought in turbomachines. In addition, there is the problem that layers for avoiding adhering material often contain Cr(VI) compounds which, owing to their health-endangering properties and the processing difficulties resulting from the stringent safety requirements, are not feasible to use.

It is therefore an object of the present invention to provide a coating which provides anti-ice properties for components of turbomachines. The corresponding coating should be able to be reliably used under the environmental conditions of a turbomachine and allow safe and uncomplicated production, processing and use.

### SUMMARY OF THE INVENTION

This object is achieved by a composition for producing a coating for components of a turbomachine having anti-ice properties, a process for producing such a coating and a coating and a component of a turbomachine having such a coating, as indicated in the present independent claims. Advantageous embodiments are subject matter of the dependent claims.

The invention proposes, for producing a coating for components of a turbomachine having anti-ice properties, a composition which comprises a binder having at least one silicon-organic constituent, ceramic particles, boron nitride particles and at least one solvent, wherein the composition further comprises polytetrafluoroethylene and/or graphite. Such a composition makes it possible to produce a coating having good anti-ice properties on components of an aircraft engine, in particular on blades in the compressor of a corresponding turbomachine.

The ceramic particles of the composition can have an average or maximum grain size of less than 4 μm and the boron nitride particles can have an average or maximum grain size of less than 12 μm. The use of such particles having a small particle size of the ceramic particles and/or boron nitride particles used enables the aerodynamic properties of a corresponding coating for turbomachines to be achieved. In particular, it is in this way possible to produce a coating which has an average surface peak-to-valley height of ≦6 μm, in particular ≦2 μm. The average surface peak-to-valley height of ≦6 μm or ≦2 μm not only improves the aerodynamic properties of the coating and the components provided with the coating to such an extent that use in turbomachines is feasible but also improves the anti-ice properties by smoothing the surface.

The ceramic particles can comprise one or more components such as aluminum oxide, titanium oxide, silicon oxide, aluminosilicate, zirconium oxide, feldspar, zeolites and kaolin. The oxide ceramic particles such as aluminum oxide, titanium oxide, aluminosilicate can here have particle sizes in the range from ≧0.2 μm to less than 4 μm.

When grain sizes or particle sizes are indicated, they always relate to an average grain size or a maximum grain size of the respective fraction, unless expressly indicated otherwise.

The binder of the respective composition has at least one silicon-organic constituent. Here, silicon-organic means that the constituent is a carbon compound having silicon components, which can be formed, for example, by alkoxysilanes and polysiloxanes. The binder can comprise one or more of these silicon-organic constituents and combinations thereof.

The composition can further comprise process additives. For the purposes of the present invention, process additives are additions which during processing give the composition particular properties, for example dispersants, antifoamers, leveling agents, thickeners, etc.

The solvent of the composition can be formed by an organic solvent, in particular alcohol and/or water.

The composition can have a solids content between 10% by weight and 40% by weight, in particular 20% by weight to 30% by weight.

The boron nitride can be present in a proportion of from 5% by weight to 50% by weight, in particular from 10% by weight to 15% by weight, based on the solids content, while the ceramic particles can be present in a proportion of from 5% by weight to 50% by weight, preferably from 10% by weight to 20% by weight.

A composition as indicated above can be applied to a component of a turbomachine which is to be coated and subsequently dried and cured in order to form an anti-ice coating. Application can be effected in any suitable way for example by painting, squirting, spraying or dipping the component into the respective composition.

Curing can be effected by heat treatment at a temperature between 200° C. and 350° C., in particular between 250° C. and 300° C., for a time of from 10 minutes to 120 minutes, in particular from 15 minutes to 60 minutes. The heat treatment can here be carried out in air.

In one embodiment, the composition can be applied in several sub-layers to the component to be coated, with preceding sub-layers firstly being dried and cured at room temperature before a subsequent sub-layer is applied and dried in the same way.

The dried sub-layers can then be cured together. However, curing of individual sub-layers after application is also conceivable.

It is possible to apply in total such a number of sub-layers that the layer thickness of the layer formed is in the range from 5 μm to 30 μm, in particular from 10 μm to 20 μm.

The finished deposited coating has a matrix composed of a binder which comprises at least one silicon-organic compound. Ceramic particles and boron nitride particles are embedded in this matrix and these are taken up into the matrix homogeneously and uniformly distributed. The ceramic particles in the composition indicated above can have an average or maximum grain size of less than 4 μm and the boron nitride particles can have an average or maximum grain size of less than 12 μm.

The silicon-organic compounds and also the ceramic particles which are present in the coating correspond to the materials indicated for the composition or the products thereof after curing, e.g. the hydrolyzate of the silicon-organic compound(s), so that repetition of the description can be dispensed with.

A corresponding coating can have an average surface peak-to-valley height of ≦6 μm, in particular ≦2 μm. The surface peak-to-valley height (IQ is defined here by a predetermined measurement distance on the surface of the workpiece being divided into seven equal-sized individual measurement distances, and the profile being measured in the individual measurement distances and the difference between maximum and minimum value being determined. The maximum or minimum value here relates to the maximum or minimum height or depth of the surface layer. The average of five of the partial distances indicated above is calculated and the peak-to-valley height which has been determined in this way is obtained.

In an advantageous example, the coating can be arranged on a compressor blade of an aircraft engine. It is advantageous here that the coating is easy to remove and can thus be reapplied when required.

### WORKING EXAMPLE

In an example, 620 g of a polyester-modified polysiloxane is placed in a covered 2000 ml glass beaker and stirred with 200 g of butyl acetate at room temperature for 1 h by means of a high-speed stirrer in a fume hood. 60 g of a submicron titanium dioxide (from Sachtleben) and 65 g of a micron aluminum titanate (from Alroko) and 80 g of aluminum oxide CT1200SG are subsequently added as powders and the mixture is stirred for a further 30 minutes. The materials can also be made up separately as a powder mixture beforehand.

After reduction of the speed of rotation to 200 rpm, 15 g of graphite and 10 g of a commercial leveling additive (BYK) are added and the mixture is stirred for a further 30 minutes. After spreading a sample on glass, which sample should be free of lumps, the coating material is placed in an SATA-HVLP low-pressure spray gun and sprayed at 2 bar onto the component. After air drying at room temperature for one hour, baking is carried out at 250° C. for one hour. After baking, a layer thickness of about 10 μm is obtained.

The finished coating, which extends at least partly over the compressor blade, has, owing to the fine ceramic particles and boron nitride particles, a low average peak-to-valley height which gives the coated component advantageous smoothness which improves both the anti-ice properties and also the aerodynamic requirements of a compressor blade in a turbomachine.

While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1-14. (canceled)

15. A composition for producing a coating for a component of a turbomachine having anti-ice properties, where the composition comprises a binder which comprises at least one silicon-organic constituent, ceramic particles, boron nitride particles, a solvent, and at least one of polytetrafluoroethylene and graphite.

16. The composition of claim 15, wherein the composition comprises polytetrafluoroethylene.

17. The composition of claim 15, wherein the composition comprises graphite.

18. The composition of claim 15, wherein the ceramic particles have an average or maximum grain size of less than or equal to 4 μm and/or the boron nitride particles have an average or maximum grain size of less than or equal to 12 μm.

19. The composition of claim 15, wherein the at least one silicon-organic constituent comprises at least one of an alkoxysilane and a polysiloxane.

20. The composition of claim 15, wherein the ceramic particles comprise one or more of aluminum oxide, titanium oxide, silicon oxide, zirconium oxide, an aluminosilicate, feldspar, a zeolite, kaolin.

21. The composition of claim 15, wherein the composition further comprises process additives.

22. A process for producing a coating for a component of a turbomachine having anti-ice properties, wherein the process comprises applying the composition of claim 15 to the component and subsequently curing the composition.

23. The process of claim 22, wherein the applied composition is cured at a temperature of from 200° C. to 350° C. for 10 minutes to 120 minutes.

24. The process of claim 22, wherein the applied composition is cured at a temperature of from 250° C. to 300° C. for 15 minutes to 60 minutes.

25. The process of claim 22, wherein the composition is applied in several sub-layers.

26. The process of claim 25, wherein a first sub-layer comprising the composition is applied and dried and, after drying the first sub-layer, a second sub-layer comprising the composition is applied and dried, whereafter the entire layer is cured.

27. A coating for a component of a turbomachine having anti-ice properties, wherein the coating comprises a matrix composed of a binder which comprises at least one silicon-organic compound, ceramic particles and boron nitride particles homogeneously and uniformly distributed in the matrix, as well as at least one of polytetrafluoroethylene and graphite.

28. The coating of claim 27, wherein the ceramic particles have an average or maximum grain size of less than or equal to 4 μm and/or the boron nitride particles have an average or maximum grain size of less than or equal to 12 μm.

29. The coating of claim 27, wherein the coating has a thickness of from 5 μm to 30 μm.

30. The coating of claim 29, wherein the coating has a thickness of from 10 μm to 20 μm.

31. The coating of claim 27, wherein the coating has an average surface peak-to-valley height of less than or equal to 6 μm.

32. The coating of claim 29, wherein the coating has an average surface peak-to-valley height of less than or equal to 2 μm.

33. A component of a turbomachine, wherein the component has thereon the coating of claim 27.

34. The component of claim 33, wherein the component is a compressor blade.
